(19) United States
(12) Patent Application Publication
(10) Pub. No.: US 2026/0127007 A1
(43) Pub. Date: May 7, 2026

(54) NON-TRANSITORY COMPUTER-READABLE MEDIUM AND APPARATUS FOR DOWNLOADING CONFIGURATION DATA

(71) Applicants: Miraben PATEL, Folsom, CA (US); Avi MORALI, Modiin Macabim Reut (IL); Manoj THAYILTHEKKATHIL, Livermore, CA (US); Sean DARDIS, Forest Grove, OR (US); William O'NEILL, Fair Oaks, CA (US); Sumana VENUR, Hillsboro, OR (US); Kamraan NASIM, Folsom, CA (US); Ingrid MURPHY, San Jose, CA (US); Marian CRETU, Santa Clara, CA (US); Daniel APPERLOO, Delta (CA); Anthony GIARDINA, Colfax, CA (US); Pawan CHHABRA, Bangalore (IN); Marcus WINSTON, Aloha, OR (US)

(72) Inventors: Miraben PATEL, Folsom, CA (US); Avi MORALI, Modiin Macabim Reut (IL); Manoj THAYILTHEKKATHIL, Livermore, CA (US); Sean DARDIS, Forest Grove, OR (US); William O'NEILL, Fair Oaks, CA (US); Sumana VENUR, Hillsboro, OR (US); Kamraan NASIM, Folsom, CA (US); Ingrid MURPHY, San Jose, CA (US); Marian CRETU, Santa Clara, CA (US); Daniel APPERLOO, Delta (CA); Anthony GIARDINA, Colfax, CA (US); Pawan CHHABRA, Bangalore (IN); Marcus WINSTON, Aloha, OR (US)

(21) Appl. No.: 19/389,466

(22) Filed: Nov. 14, 2025

(51) Int. Cl. G06F 9/4401

(52) U.S. Cl. CPC G06F 9/4403

(57) ABSTRACT

It is provided a non-transitory computer-readable medium storing instructions that, when executed by a processing circuitry of an apparatus, causing the processing circuitry to perform locally on the apparatus a method. The method includes transmitting, to a boot controller of the computing system, a request to initiate a single-block transfer of full configuration data corresponding to the firmware of the component. The request comprises a destination address within a local memory of the component and a size of the configuration data. The method further includes receiving, from the boot controller, an acknowledgement indicating that the full configuration data has been loaded as a single block into the local memory at the destination address. The method further includes in response to the acknowledgement, parsing the single block of the full configuration data residing in the local memory to apply one or more configuration settings for the component.

### BACKGROUND

Computing systems may comprise multiple processing components that may require configuration during initialization to establish operational parameters such as voltage settings, frequency tables, power limits, and thermal thresholds. During system boot operations, configuration data may need to be distributed from central control entities to various processing components to enable proper functionality. The efficiency of configuration data distribution may affect overall boot time performance, which may be particularly important in systems where rapid initialization is required. As computing systems become more complex, and as configuration requirements may expand to support diverse operational modes and features, the distribution of configuration data during boot operations may present challenges related to performance, scalability, and maintainability.

### BRIEF DESCRIPTION OF THE FIGURES

Some examples of apparatuses and/or methods will be described in the following by way of example only, and with reference to the accompanying figures, in which

FIG. 1 illustrates a block diagram of an example of a non-transitory computer-readable medium;

FIG. 2. illustrates a block diagram of an example of an apparatus;

FIG. 3 illustrates a flowchart of an example of a method;

FIG. 4. illustrates a block diagram of an example of an apparatus;

FIG. 5 illustrates a flowchart of an example of a method;

FIG. 6 illustrates an example of a system for configuration data distribution in a computing system;

FIG. 7 illustrates an example of a system for configuration data download in a computing system using a multi-chunk mailbox-based approach; and

FIG. 8 illustrates an example of a block diagram of an electronic apparatus.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

The disclosed technique may enable efficient configuration data (also referred to as blob) distribution in computing systems comprising multiple firmware components. In computing systems with multiple firmware components, such as those implemented in system-on-chip architectures, components may be required to have their configurations downloaded into local memory during boot operations. The disclosed approach may enable configurations to be downloaded as separate blocks of data to firmware components through single-block transfer operations. The disclosed technique may allow a boot controller (such as a converged security controller) to communicate any number of configurations to any component using a simple single load command format (such as an IP-patch load command format) to load configuration data into the component's local memory as a block of data. The disclosed method may allow the configuration definition and parsing to be localized solely at the component level. Each component may define its own configuration data structure and parsing logic without requiring the boot controller or other firmware modules to understand the configuration format. The component firmware may then parse and validate the integrity of the configuration data and may consume the data for internal usage.

The disclosed approach may improve boot time performance, maintainability, scalability, architectural simplification, and security. The disclosed technique may reduce boot time latency because downloading a configuration block may be one single-block transfer event and may not require the component to serve multiple high priority interrupt events for each small chunk of configuration data as would be required in legacy mailbox-based approaches. The disclosed technique may enable easier maintenance of backward compatibility because the parsing of configurations may be abstracted within the component firmware and may not require shared documentation and application programming interfaces (APIs) to be maintained across different projects or product generations. The disclosed technique may improve scalability because the boot controller firmware may implement a unified transfer method for all configuration downloads across all components, which may remove the complexity of supporting varying requirements for different component types. The disclosed technique may simplify the firmware architecture by removing the requirement for intermediary staging firmware to act as a staging agent for configuration data, simplifying the flow to involve only requester and responder firmware components. The disclosed technique may provide a more secure approach to load configuration data compared to mailbox communication because the configuration data may be authenticated as a complete block before transfer and may be loaded directly into protected local memory rather than being transmitted piecemeal through multiple observable mailbox transactions on shared communication interfaces.

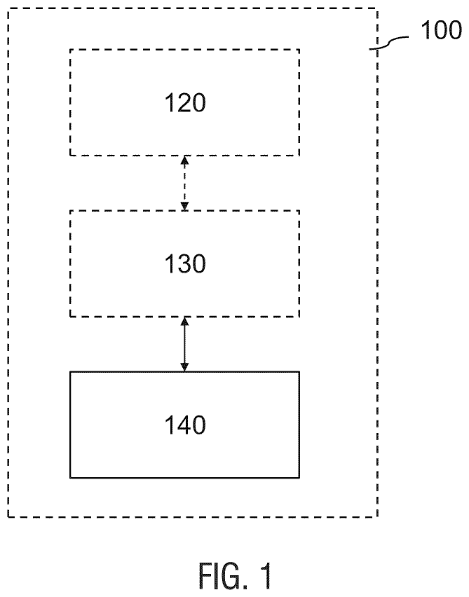

FIG. 1 illustrates a block diagram of an example of a non-transitory computer-readable medium 140. For example, the non-transitory computer-readable medium 140 may store firmware instructions of a component of a computing system. The non-transitory computer-readable medium 140 stores firmware instructions that, when executed by a processing circuitry, such as processing circuitry 130 of the component, cause the processing circuitry to perform a method. The processing circuitry may access the non-transitory computer-readable medium 140 via an interface circuitry, such as interface circuitry 120. In some examples, the non-transitory computer-readable medium 140 may be included in the component, which may also comprise the processing circuitry 130 and the interface circuitry 120.

For example, the non-transitory computer-readable medium 140 may refer to any tangible, physical medium capable of storing instructions, data, or other types of information for access by a computer, processor, or similar electronic device. The computer-readable medium may be non-transitory in that medium may have a persistent or enduring form. The non-transitory computer-readable medium may comprise one or more of the following computer-readable mediums: magnetic storage devices, such as hard disk drives (HDDs) and magnetic tapes, which store data using magnetic patterns and are commonly used for long-term data storage in computers, servers, and backup systems. Optical storage media, including compact discs (CDs), digital versatile discs (DVDs), and Blu-ray discs, utilize laser technology to read and write data, offering durability and longevity for storing software, media, and backups. More modern forms include solid-state devices (SSD), which rely on flash memory technology without moving parts, such as USB flash drives, secure digital (SD) cards, and internal/external SSDs, valued for their fast read/write speeds and portability. Additionally, non-volatile memory chips like read-only memory (ROM) and programmable ROM (PROM) store critical firmware or embedded software, commonly found in embedded systems and computers. Memory technologies, such as phase-change memory (PCM), magnetoresistive RAM (MRAM), and ferroelectric RAM (FeRAM), offer persistent data storage with high reliability, speed, and power efficiency, making them ideal for applications requiring rapid access and data retention, such as in mobile devices, high-performance computing, and industrial systems.

For example, the one or more processing circuitries 130 may access the non-transitory computer-readable medium 140 over the interface circuitry 120. For example, the one or more processing circuitries 130 may then execute the instructions stored on the non-transitory computer-readable medium 140. The execution of the instructions stored on the non-transitory computer-readable medium 140 causes the one or more processing circuitries 130 to the perform the method for attestation of a running workload in a trusted execution environment.

For example, the processing circuitry 130 of the component may access the non-transitory computer-readable medium 140 over the interface circuitry 120. For example, the processing circuitry 130 may then execute the firmware instructions stored on the non-transitory computer-readable medium 140. The execution of the firmware instructions causes the processing circuitry to perform the method, such as method 300.

For example, the computing system may be an electronic system comprising one or more processing elements, memory elements, and interconnection infrastructure capable of executing instructions and performing computational tasks. The computing system may be a server, desktop computer, laptop computer, embedded system, mobile device, or specialized computing platform. The computing system may comprise a plurality of interconnected components that communicate via buses, networks, or other communication interfaces. The computing system may be implemented as a single integrated circuit, as multiple discrete components on a circuit board, or as a distributed system across multiple physical devices. In some examples, the apparatus 100 may be part of the computing system. For example, the apparatus 100 may represent the component within the computing system. For example, the processing circuitry 130 may execute the firmware instructions stored on the non-transitory computer-readable medium 140. The interface circuitry 120 may enable the apparatus 100 to communicate with other components or subsystems of the computing system.

In some examples, the component may be integrated within a system-on-chip (SoC). For example, a SoC may be an integrated circuit that consolidates multiple functional components of a computing system onto a single semiconductor substrate or die. The SoC may represent an advanced integration approach where diverse functional blocks that traditionally existed as separate, discrete integrated circuits are instead fabricated together on a single piece of silicon. The SoC may integrate processing cores, memory controllers, input/output interfaces, specialized accelerators, power management units, graphics processors, communication interfaces, security processors, and other functional blocks. The SoC may enable reduced physical footprint, lower power consumption, improved performance through shorter interconnect distances, enhanced integration, and lower manufacturing costs compared to multi-chip architectures using separate components on a printed circuit board.

For example, the component may be integrated as part of the SoC. For example, the component may be fabricated as part of the SoC manufacturing process and may share the same silicon die with other components. The component integrated within the SoC may communicate with other integrated components through on-chip interconnect fabrics, buses, network-on-chip architectures, or direct point-to-point connections. The multiple functional blocks within the SoC may operate under coordinated power management, share common clock domains or operate in separate clock domains, and may be designed to work together as a cohesive system. In such implementations, the component may be a power management controller, a graphics controller, a system-level controller, or another specialized processing unit formed as an intellectual property block within the SoC.

For example, the component of the computing system may be a functional unit (also referred to as intellectual property (IP) block) within the computing system that performs a specific set of operations. The component may comprise dedicated processing circuitry, local memory resources, and/or interface circuitry for communication with other components.

For example, the component may be a power management controller, a graphics controller, a system-level controller, a communications processor, a security processor, an audio processor, a video encoder, a video decoder, an image signal processor, a neural processing unit, a digital signal processor, a memory controller, and/or any other specialized processing unit. The component may be physically integrated within an SoC alongside other components, or may be implemented as a discrete processing unit. For example, the power management controller may regulate voltage levels, control power states, manage thermal conditions, and coordinate power delivery to various subsystems of the computing system.

In some examples, the component may be a power management controller acting as a boot orchestrator. For example, the boot orchestrator may be a component or functional unit responsible for controlling the order, timing, and coordination of initialization operations for multiple components during the boot process. The boot orchestrator may determine which components should be initialized, in what sequence the initialization should occur, and when each component is ready to proceed to the next boot stage. The boot orchestrator may send commands or requests to the boot controller to trigger loading operations for various components, may monitor the completion status of initialization operations, and may coordinate dependencies between components where one component's initialization may depend on another component being initialized first. The boot orchestrator may execute boot orchestration firmware that defines the boot sequence logic and coordinates the activities of other components during boot. The boot orchestrator may be the first component to become operational during the boot sequence, or may assume orchestration responsibilities at a particular stage of the boot process. The boot orchestrator may request its own configuration data from the boot controller, and may then, after successfully loading and applying its own configuration settings, proceed to coordinate the initialization of other components. For example, the power management controller may be suited to act as a boot orchestrator because the power management controller may control power delivery to other components and may need to ensure that power rails are stable and properly sequenced before other components can safely initialize. In some examples, the power management controller may be among the first components to become operational during boot, may coordinate the power-up sequence of other components, and may manage the overall boot orchestration by requesting configuration data loads for itself and for other components in the proper sequence.

The graphics controller may process graphical data, render images, manage display outputs, and execute graphics-specific computations. The system-level controller may orchestrate boot sequences, coordinate inter-component communication, manage system resources, and provide centralized control functions. The communications processor may handle network protocols, manage data transmission and reception, and interface with communication hardware. The security processor may perform cryptographic operations, manage secure boot processes, enforce access controls, and protect sensitive data. An audio processor may process audio signals, manage audio codecs, and control audio input and output streams.

The video encoder may compress video data into specified formats, while a video decoder may decompress encoded video streams for playback. The image signal processor may process raw image data from camera sensors, perform color correction, noise reduction, and image enhancement. The neural processing unit may accelerate machine learning operations, execute neural network inference, and perform tensor computations. The digital signal processor may execute specialized mathematical operations on digital signals for applications in communications, audio processing, and control systems. The memory controller may manage access to memory devices, control memory timing, and optimize memory bandwidth allocation. The component may execute firmware instructions to control its operations, manage its configuration settings, and coordinate with other components of the computing system.

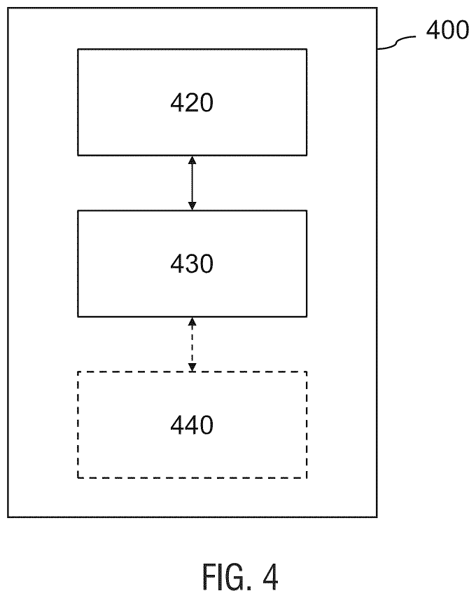

The method comprises transmitting, to a boot controller (for example apparatus 400 in FIG. 4) of the computing system, a request to initiate a single-block transfer of full configuration data corresponding to the firmware of the component. The request comprises a destination address within a local memory of the component and a size of the configuration data. For example, the boot controller (for example apparatus 400 in FIG. 4) of the computing system may be a component comprising hardware and/or firmware subsystems responsible for managing initialization, authentication, and configuration distribution to components during system startup and boot processes. The boot controller may be a separate functional unit distinct from the component and from main processing units such as central processing units or graphics processing units. The boot controller may orchestrate the sequence of operations required to bring the computing system from a powered-off or reset state to a fully operational state. The boot controller may authenticate the firmware instructions of the component and the configuration data corresponding to the firmware of the component by reading from non-volatile memory such as flash memory. The boot controller may load the firmware instructions into the local memory of the component and/or may initiate transfer of the configuration data to the local memory of the component. The boot controller may coordinate the initialization order of multiple components within the computing system. The boot controller may have privileged access to non-volatile memory storing the firmware instructions and the configuration data, and may have the authority to initiate transfers of the firmware instructions and/or the configuration data to the component. The boot controller may command hardware transfer mechanisms to perform the actual data movement from the non-volatile memory to the local memory of the component. The boot controller may implement security policies, verify cryptographic signatures of the firmware instructions and the configuration data, and/or ensure that only authorized firmware instructions and configuration data are loaded into the component. In some examples, the boot controller may be implemented as a dedicated microcontroller, a security processor, an embedded controller, or an intellectual property block within a system-on-chip with its own processing resources and firmware.

In some examples, the boot controller may be a secure boot controller implementing enhanced security measures during the boot process. For example, a secure boot controller may verify the authenticity and integrity of the firmware instructions of the component and the configuration data corresponding to the firmware of the component before initiating distribution using cryptographic signatures, hash verification, or other authentication mechanisms. The secure boot controller may enforce a chain of trust ensuring that each stage of the boot process is authenticated before proceeding to the next stage. The secure boot controller may prevent the loading of unauthorized, modified, or corrupted firmware instructions or configuration data by validating digital signatures against trusted public keys or certificates stored in protected memory. The secure boot controller may implement secure storage and handling of cryptographic keys, may operate within a trusted execution environment, and may be resistant to tampering or unauthorized access. The secure boot controller may log security events, detect boot-time attacks, and initiate protective responses such as refusing to boot or reverting to a known-good configuration. In some examples, the secure boot controller may be implemented as a converged security controller integrating multiple security functions with boot orchestration capabilities within a single functional unit.

For example, the firmware (also referred to as firmware instructions) of the component may comprise executable program code specific to the component that defines the operational behavior, control logic, and/or functional routines of the component. The firmware may be stored in non-volatile or persistent memory 140 and may be loaded into executable memory when the component is initialized or powered on. The firmware instructions may include boot code, initialization routines, operational control algorithms, communication protocols, and error handling procedures specific to the component's function within the computing system. In some examples, the firmware may remain relatively static across operational cycles and may be updated through firmware update procedures.

In some examples, the method may further comprise, prior to transmitting the request, receiving the firmware instructions of the component loaded by the boot controller into the local memory of the component. The boot controller may load the firmware instructions from non-volatile memory into the local memory of the component before the component begins executing the firmware instructions. The firmware instructions and the configuration data may reside in different regions or portions of the local memory of the component, but both may be local to the component for direct access by the processing circuitry. The boot controller may load the firmware instructions first, enabling the processing circuitry to begin executing the firmware instructions, and the executing firmware instructions may then cause the processing circuitry to transmit the request for the configuration data. The firmware instructions may be loaded into an executable code region of the local memory, while the configuration data may subsequently be loaded into a data region of the local memory at the destination address specified in the request. Both the firmware instructions and the configuration data may be accessible to the processing circuitry without requiring access to external memory or non-volatile storage during operation.

For example, the configuration data corresponding to the firmware of the component may comprise to parameters such as settings, tables, and/or values, that control the behavior of the firmware instructions during execution. For example, the configuration data may define operational limits, performance characteristics, timing parameters, voltage and/or frequency settings, thermal thresholds, feature enablement flags, and/or other adjustable parameters that affect how the firmware instructions operate. The configuration data may be separate from the firmware instructions themselves and may vary between different system configurations, product variants, or operational modes even when the same firmware instructions are used. For example, in a power management controller, the firmware instructions may contain the algorithms for voltage regulation and power state management, while the configuration data may specify the actual voltage levels, power limits, frequency tables, and thermal thresholds to be applied. The firmware instructions may read and apply the configuration data to adapt their operation to the specific requirements of the computing system.

For example, the request to initiate the single-block transfer may be a message transmitted to the boot controller to initiate the loading of the configuration data. For example, the processing circuitry 130, which may be part of the component, may transmit the request to the boot controller by executing the firmware instructions stored on the non-transitory computer-readable medium 140. The firmware instructions, when executed, may cause the processing circuitry 130 to generate the request. The request may be transmitted during a boot sequence or initialization phase when the component requires its configuration data to become operational. The request may be formatted according to a defined communication protocol between the component and the boot controller. The request may be transmitted over a communication interface such as a bus, a mailbox interface, a message queue, a register-based interface, or another inter-component communication mechanism. The request may comprise one or more data fields encoding information necessary for the boot controller to locate, authenticate, and transfer the appropriate configuration data to the component.

For example, the request may comprise a destination address within a local memory of the component specifying where the configuration data should be loaded. The destination address may be a physical memory address, a virtual memory address, or an offset within the local memory of the component. The destination address may point to a region of static random-access memory (SRAM), dynamic random-access memory (DRAM), or another type of memory local to the component. The component may allocate or reserve a portion of its local memory to receive the configuration data and may specify this allocated region in the destination address field of the request.

For example, the request may comprise a size of the configuration data indicating the amount of data to be transferred. The size may be expressed in bytes, words, kilobytes, or another unit of data measurement. The size may inform the boot controller of how much data should be read from the non-volatile memory and transferred to the component. The size may also inform hardware transfer mechanisms of the transfer length required to complete the single-block transfer.

In some examples, the request may comprise additional fields such as a component identifier identifying which component is making the request, a configuration type identifier specifying which configuration data set is being requested, a priority level indicating urgency of the request, or authentication credentials verifying the authority of the component to request the configuration data. The request may be formatted as a data structure, a register write operation, a mailbox command, or a packet transmitted over an interconnect fabric

The boot controller is requested to initiate perform the transfer of the full configuration data in a single block. For example, the block may be a contiguous segment of data treated as a single unit for transfer operations from a source to a destination. The block may comprise multiple bytes, words, kilobytes, or megabytes organized sequentially in memory and addressable as one cohesive unit. The block may represent a logically continuous data structure where all data elements are arranged in adjacent memory locations without gaps or discontinuities. The block may be defined by a starting address and a size, where the size indicates the total number of bytes or words contained in the block. The block may exist as a contiguous allocation in the destination memory after transfer, regardless of whether the source data was stored contiguously or non-contiguously prior to transfer. The block may be written to destination memory as an indivisible unit where all data elements occupy sequential address locations. The block structure may enable efficient data transfer by allowing hardware transfer mechanisms to perform sequential write operations across a continuous destination address range without requiring repeated setup or command overhead for each individual data element.

For example, the single block may refer to one unified, contiguous block of data as perceived and handled by the component receiving the transfer. The single block may indicate that from the perspective of the component and the transfer operation to the component's local memory, the data arrives and is written as one continuous, uninterrupted sequence without division into multiple separate blocks. The single block may be transferred through one transfer command issued to a hardware transfer mechanism rather than requiring multiple transfer commands for transferring multiple blocks sequentially. The single block transfer may write data continuously to the destination memory of the component, filling adjacent memory locations from a starting destination address to an ending destination address without gaps or interruptions. The single block may be received by the component as one contiguous data unit residing in one continuous memory region of the local memory, even if the source data was originally stored in non-contiguous locations in non-volatile memory. The boot controller may assemble data from multiple non-contiguous source locations in the non-volatile memory into a single contiguous block prior to or during the transfer operation, such that the component receives the data as a single block. The single block transfer may contrast with a multi-block transfer where data is divided into multiple separate, distinct blocks that are transferred through multiple separate commands, potentially written to non-contiguous destination memory regions, or transferred at different times as independent transfer operations.

For example, the full configuration data may comprise the entirety of configuration data that is transferred from non-volatile memory to the local memory of the component in the transfer operation. The full configuration data may encompass all configuration parameters, settings, tables, and values that are stored in the non-volatile memory for the component and that are designated for loading into the local memory during the transfer. The full configuration data may comprise all configuration items intended to be transferred from the non-volatile storage to the local storage of the component, without omitting any portion of the stored configuration dataset. The full configuration data may represent a complete transfer of the configuration data set from its storage location in non-volatile memory to its operational location in the local memory of the component. The full configuration data may be stored in the non-volatile memory in contiguous locations or in non-contiguous locations distributed across different regions, sectors, or addresses of the non-volatile memory. The full configuration data, once transferred, may reside entirely in the local memory of the component where the firmware can access it. The full configuration data may be distinguished from partial transfers where only a subset of the stored configuration data is transferred, from incremental transfers where configuration data is transferred in portions over multiple operations, or from selective transfers where only certain configuration parameters are moved from non-volatile memory to local memory while others remain in non-volatile memory. For example, if ten kilobytes of configuration data for a power management controller are stored across multiple regions in flash memory, the full configuration data may comprise all ten kilobytes that are read from the flash memory and transferred to the local memory of the power management controller, as opposed to transferring only five kilobytes while leaving the remaining five kilobytes in flash memory to be accessed later or transferred separately.

For example, transferring full configuration data in a single block may comprise transferring all configuration parameters required by the firmware to the component as one contiguous data unit through one transfer operation. The boot controller may read the full configuration data from one or more locations in non-volatile memory, which may be stored contiguously in a single region or distributed across multiple non-contiguous regions of the non-volatile memory. The boot controller may authenticate the full configuration data after assembling it from potentially non-contiguous source locations. The boot controller may then initiate a single-block transfer by issuing one transfer command to a hardware transfer mechanism specifying the destination address in the local memory of the component and the size of the full configuration data. The hardware transfer mechanism may execute the transfer by writing all configuration data continuously to a contiguous region of the local memory starting at the destination address and proceeding sequentially until all bytes of the full configuration data have been written to adjacent memory locations. From the perspective of the component, the full configuration data arrives as a single contiguous block in the local memory, regardless of whether the data was originally stored contiguously or non-contiguously in the non-volatile memory. The component may then access the full configuration data as one contiguous block starting at the known destination address. For instance, if a power management controller requires fifty different configuration parameters totaling 2 kilobytes of data, and these parameters are stored in three separate non-contiguous regions of flash memory, the boot controller may read from all three regions, assemble the 2 kilobytes of data, authenticate it, and then transfer all 2 kilobytes as a single block to a contiguous 2-kilobyte region in the local memory of the power management controller through one transfer command. The hardware transfer mechanism writes the 2 kilobytes continuously to destination addresses, for example, from address 0x1000 to address 0x17FF in the local memory, without requiring separate commands for each of the three source regions and without writing to non-contiguous destination addresses. In previous approaches the fifty parameters might be transferred individually through fifty separate mailbox messages, or where the three source regions might result in three separate block transfers to potentially non-contiguous destinations requiring three separate transfer commands and three separate regions in the destination memory.

The method further comprises receiving, from the boot controller, an acknowledgement indicating that the full configuration data has been loaded as a single block into the local memory at the destination address. For example, the full configuration data may be loaded as a single block into the local memory at the destination address by writing the data continuously to a contiguous region of the local memory starting from the destination address. The loading may be performed by the hardware transfer mechanism that receives a transfer command from the boot controller specifying the destination address and the size of the full configuration data. The hardware transfer mechanism may read the full configuration data from non-volatile memory or from an intermediate buffer where the boot controller has assembled and authenticated the data. The hardware transfer mechanism may then write the data sequentially to the local memory, beginning at the destination address and continuing through adjacent memory addresses until all bytes of the full configuration data have been written. The loading as a single block may comprise the write operation proceeding continuously without interruption, without writing to non-contiguous memory regions, and without requiring multiple separate write commands. The destination address may specify the starting location in the local memory, and the data may fill memory locations from the destination address through an ending address determined by the destination address plus the size of the full configuration data. For example, if the destination address is 0x2000 in the local memory and the full configuration data is 4 kilobytes in size, the data may be loaded continuously into memory addresses from 0x2000 to 0x2FFF as a single contiguous block. The local memory may be static random-access memory (SRAM), embedded DRAM, or another type of memory physically located within or directly accessible to the component. After the loading is complete, the full configuration data may reside entirely within the specified contiguous region of the local memory where the firmware of the component can directly access it for parsing and application.

For example, the acknowledgement may comprise a response message transmitted from the boot controller to the component confirming that a requested operation has been completed. The acknowledgement may indicate that the full configuration data has been loaded may inform the component that the transfer operation has finished successfully and that the full configuration data is now available in the local memory at the destination address. The acknowledgement may be transmitted after the hardware transfer mechanism completes writing all data to the local memory and reports completion to the boot controller. The boot controller may verify that the transfer is completed without errors before sending the acknowledgement. The acknowledgement may be implemented as a message sent over a communication interface between the boot controller and the component, as a status bit or flag set in a shared register accessible to the component, as an interrupt signal asserted to the processing circuitry 130 of the component, or as a response to the original request message. The acknowledgement may include additional information such as a completion status code, error flags if any errors occurred, a checksum or hash of the transferred data for verification, or a timestamp indicating when the transfer completed. The acknowledgement may enable the component to proceed with parsing and using the configuration data, as the component may wait for the acknowledgement before attempting to access the configuration data in local memory. For example, the acknowledgement may be sent as a mailbox message from the boot controller to the component, or may be indicated by the boot controller writing a completion status value to a register that the processing circuitry of the component polls or receives as an interrupt.

The method comprises further in response to the acknowledgement, parsing the single block of the full configuration data residing in the local memory to apply one or more configuration settings for the component. For example, parsing the single block of the full configuration data may comprise analyzing, interpreting, and/or extracting individual configuration parameters from the contiguous block of data residing in the local memory. The parsing may be performed by the processing circuitry 130 of the component executing the firmware instructions. The parsing may involve reading the data from the local memory starting at the destination address, identifying the structure and format of the configuration data, and separating the single block into its constituent configuration parameters, values, tables, or data structures. For example, the parsing may interpret the organization of the data according to a predefined format, schema, or layout that defines how different configuration parameters are arranged within the block. For example, the configuration data block may be organized as a sequence of parameter records each containing a parameter identifier and a parameter value, or may be structured as a series of data tables with headers indicating table types and sizes. The parsing may read through the block sequentially or may use offset values to locate specific configuration parameters at known positions within the block. The parsing may validate the data during the parsing process by checking checksums, verifying data ranges, or confirming that required parameters are present.

For example, the parsing may be performed in response to the acknowledgement, meaning that the parsing operation begins after receiving the acknowledgement from the boot controller. The processing circuitry 130 may wait for the acknowledgement before initiating the parsing to ensure that the full configuration data has been completely loaded into the local memory and is ready to be accessed. Upon receiving the acknowledgement, the firmware may call a parsing routine or function that accesses the local memory at the destination address and begins processing the configuration data block. The acknowledgement may serve as a trigger or synchronization signal indicating that it is safe to proceed with parsing because the data transfer is complete. Without the acknowledgement, the processing circuitry 130 might attempt to parse incomplete or invalid data if the transfer were still in progress or had failed.

For example, applying one or more configuration settings for the component may comprise using the parsed configuration parameters to establish operational characteristics, control behaviors, or set operating points of the component. The applying may involve writing parsed configuration values to hardware registers that control the component's operation, storing configuration parameters in firmware variables or data structures that are referenced during component operation, programming configuration values into control logic, or using the configuration data to determine operational modes and behaviors. The one or more configuration settings may include voltage levels, frequency values, power limits, thermal thresholds, timing parameters, enable or disable flags for features, operational mode selections, or any other adjustable parameters that affect how the component functions. For a power management controller, applying configuration settings may include writing voltage targets to voltage regulator control registers, programming frequency tables into frequency selection logic, setting thermal threshold values in thermal monitoring circuits, and storing power limit values in firmware variables used by power management algorithms. For a graphics controller, applying configuration settings may include configuring memory bandwidth allocations, setting rendering pipeline parameters, programming display timing registers, and establishing performance targets. The applying may occur during an initialization phase of the component before the component enters its normal operational mode. After applying the configuration settings, the component may operate according to the applied settings rather than using default or generic settings. For example, if the parsed configuration data indicates that a particular voltage rail should operate at 1.2 volts with a maximum current of 50 amperes, the applying may involve writing the value 1.2 volts to a voltage setpoint register and writing the value 50 amperes to a current limit register of a voltage regulator circuit.

The above described non-transitory computer-readable medium 140 storing firmware instructions of the component that, when executed by the processing circuitry cause the processing circuitry to perform the method may enable improved boot time performance by reducing latency during configuration loading operations. The single-block transfer approach may eliminate the need to serve multiple high-priority interrupt events that would be required if configuration data were transmitted as multiple small chunks, such as 32-bit chunks sent through individual mailbox commands. For example, each mailbox command in a chunked approach may trigger an interrupt that the processing circuitry must service as a high-priority event, causing the firmware to suspend other operations, process the interrupt, extract the data chunk, and resume previous operations. The single-block transfer may be complete as one transfer operation without requiring the processing circuitry 130 to handle multiple interrupts for individual data chunks, thereby significantly reducing the total time required to load configuration data during boot sequences.

The method may enable reduced maintenance overhead and improved backward compatibility across different firmware versions. The parsing of the configuration data may be abstracted entirely within the firmware of the component, meaning that the component firmware may define and modify the structure, format, and interpretation of the configuration data without requiring changes to other firmware modules or shared application programming interfaces. The method may eliminate the requirement for intermediary staging firmware to process and forward configuration data, enabling direct transfer from the boot controller to the component and simplifying the architecture. The single-block transfer to local memory may provide faster access to configuration data during operation and may enable enhanced security by loading authenticated configuration data directly into protected local memory rather than transmitting parameters through multiple mailbox transactions on shared communication interfaces.

In some examples, the method may further comprise acting as a boot orchestrator by transmitting a second request to the boot controller to initiate a configuration load for a second component of the computing system. The second request may be similar in structure to the first request transmitted for the component acting as boot orchestrator, and may specify a destination address within a local memory of the second component and a size of configuration data for the second component. The component acting as boot orchestrator may determine when the second component should be initialized based on boot sequence logic, system dependencies, or operational requirements. The component acting as boot orchestrator may transmit the second request after completing its own configuration loading and initialization, or may transmit requests for multiple components in a coordinated sequence. The boot orchestrator may wait for an acknowledgement from the boot controller confirming that the second component's configuration data has been loaded before proceeding with further boot operations or before requesting configuration loads for additional components. The boot orchestrator may coordinate the initialization of multiple components by transmitting multiple requests to the boot controller for different components at appropriate times during the boot sequence. For example, the power management controller acting as boot orchestrator may first request and receive its own configuration data, then transmit a second request for configuration data of a system-level controller, then transmit a third request for configuration data of a graphics controller, coordinating the sequence to ensure that components initialize in the proper order. The boot orchestrator may enable centralized control of the boot process, may ensure that initialization operations occur in a coordinated manner, and may manage dependencies between components where certain components must be operational before others can initialize.

In some examples, the second component may comprise one of a system-level controller or a graphics controller. For example, the system-level controller may refer to a component responsible for managing system-wide functions, coordinating operations across multiple subsystems, and providing centralized control or monitoring capabilities for the computing system. The system-level controller may manage input/output operations, coordinate communication between different components, handle system-level interrupts, monitor system health and status, or provide supervisory control functions. The system-level controller may interface with peripheral devices, manage system buses, coordinate data transfers between subsystems, or implement system management protocols. The system-level controller may execute firmware that implements system management functions, may respond to system events, and may coordinate with other components to maintain overall system operation. For example, the system-level controller may manage communication with external interfaces, may coordinate power state transitions across multiple components, or may collect and report system telemetry data.

For example, the graphics controller may refer to a component responsible for processing graphical data, rendering images, managing display outputs, and executing graphics-specific computations. The graphics controller may receive graphics commands and data from a central processing unit or application processor, may process vertex data and pixel data, may perform rendering operations to generate display images, and may output signals to drive display devices. The graphics controller may implement graphics processing pipelines including vertex shaders, pixel shaders, texture mapping units, and raster operations. The graphics controller may manage graphics memory, allocate memory resources for rendering operations, and transfer rendered images to display buffers. The graphics controller may support various graphics application programming interfaces and may execute graphics-specific firmware for managing rendering operations, display configurations, and graphics resources. The graphics controller may require configuration data specifying memory bandwidth allocations, rendering pipeline configurations, display timing parameters, performance targets, and feature enablement settings.

In some examples, the second component may comprise an audio processor responsible for processing audio signals, managing audio codecs, and controlling audio input and output streams. The second component may comprise a video encoder or decoder responsible for compressing or decompressing video data. The second component may comprise a communications processor responsible for managing network protocols and data transmission. The second component may comprise a security processor responsible for cryptographic operations and secure data handling. The second component may comprise a memory controller responsible for managing access to memory devices and controlling memory operations. The second component may comprise a neural processing unit responsible for accelerating machine learning computations. The second component may comprise any specialized processing unit within the computing system that requires configuration data to be loaded during the boot sequence.

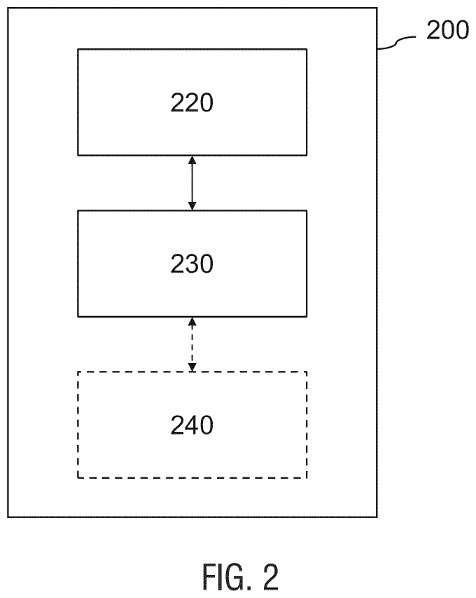

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-8).

FIG. 2. illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, the apparatus 200 may be the component within the computing system. For example, the apparatus 200 may be the computing system comprising the component. For example, the processing circuitry 130 may execute the firmware instructions stored on the non-transitory computer-readable medium 140. The interface circuitry 120 may enable the apparatus 100 to communicate with other components or subsystems of the computing system.

The processing circuitry 230 is configured to transmit, to a boot controller of the computing system, a request to initiate a single-block transfer of full configuration data corresponding to the firmware of the component. The request comprises a destination address within a local memory of the component and a size of the configuration data. The processing circuitry 230 is further configured to receive, from the boot controller, an acknowledgement indicating that the full configuration data has been loaded as a single block into the local memory at the destination address. The processing circuitry 230 is further configured to in response to the acknowledgement, parse the single block of the full configuration data residing in the local memory to apply one or more configuration settings for the component.

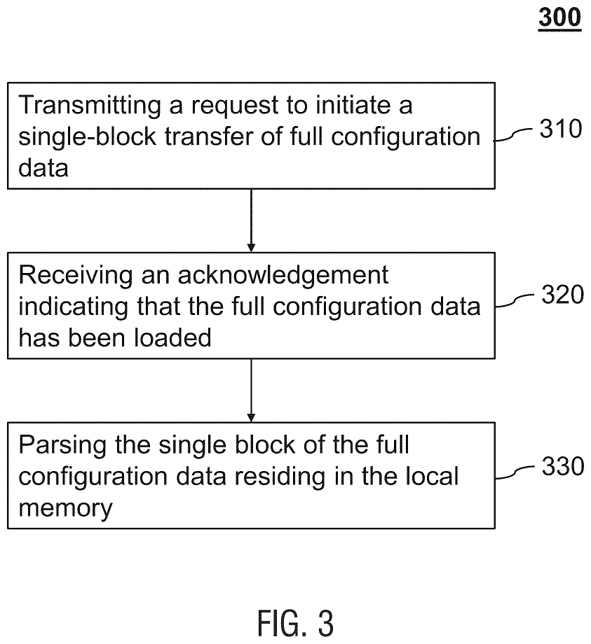

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-8).

FIG. 3 illustrates a flowchart of an example of a method 300. The method 300 may, for instance, be performed by an apparatus as described herein, such as apparatus 100 or apparatus 200. The method 300 comprises transmitting 310, to a boot controller of the computing system, a request to initiate a single-block transfer of full configuration data corresponding to the firmware of the component. The request comprises a destination address within a local memory of the component and a size of the configuration data. The method 300 further comprises receiving 320, from the boot controller, an acknowledgement indicating that the full configuration data has been loaded as a single block into the local memory at the destination address. The method 300 further comprises in response to the acknowledgement, parsing 330 the single block of the full configuration data residing in the local memory to apply one or more configuration settings for the component.

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-8).

### Boot Controller

FIG. 4. illustrates a block diagram of an example of an apparatus 400 or device 400. The apparatus 400 comprises circuitry that is configured to provide the functionality of the apparatus 400. For example, the apparatus 400 of FIG. 4 comprises interface circuitry 420, processing circuitry 430 and (optional) storage circuitry 440. For example, the processing circuitry 430 may be coupled with the interface circuitry 420 and optionally with the storage circuitry 440.

For example, the processing circuitry 430 may be configured to provide the functionality of the apparatus 400, in conjunction with the interface circuitry 420. For example, the interface circuitry 420 is configured to exchange information, e.g., with other components inside or outside the apparatus 400 and the storage circuitry 440. Likewise, the device 400 may comprise means that is/are configured to provide the functionality of the device 400.

The components of the device 400 are defined as component means, which may correspond to, or implemented by, the respective structural components of the apparatus 400. For example, the device 400 of FIG. 4 comprises means for processing 430, which may correspond to or be implemented by the processing circuitry 430, means for communicating 420, which may correspond to or be implemented by the interface circuitry 420, and (optional) means for storing information 440, which may correspond to or be implemented by the storage circuitry 440. In the following, the functionality of the device 400 is illustrated with respect to the apparatus 400. Features described in connection with the apparatus 400 may thus likewise be applied to the corresponding device 400.

In general, the functionality of the processing circuitry 430 or means for processing 430 may be implemented by the processing circuitry 430 or means for processing 430 executing machine-readable instructions. Accordingly, any feature ascribed to the processing circuitry 430 or means for processing 430 may be defined by one or more instructions of a plurality of machine-readable instructions. The apparatus 400 or device 400 may comprise the machine-readable instructions, e.g., within the storage circuitry 440 or means for storing information 440.

The interface circuitry 420 or means for communicating 420 may correspond to one or more inputs and/or outputs for receiving and/or transmitting information, which may be in digital (bit) values according to a specified code, within a module, between modules or between modules of different entities. For example, the interface circuitry 420 or means for communicating 420 may comprise circuitry configured to receive and/or transmit information.

For example, the processing circuitry 430 or means for processing 430 may be implemented using one or more processing units, one or more processing devices, any means for processing, such as a processor, a computer or a programmable hardware component being operable with accordingly adapted software. In other words, the described function of the processing circuitry 430 or means for processing 430 may as well be implemented in software, which is then executed on one or more programmable hardware components. Such hardware components may comprise a general-purpose processor, a Digital Signal Processor (DSP), a micro-controller, etc.

For example, the storage circuitry 440 or means for storing information 440 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 430 is configured to receive, from a first component of a computing system (for example apparatus 100, see FIG. 1), a request to initiate a single-block transfer of full configuration data corresponding to a firmware (for example stored in non-transitory medium 140 of FIG. 1) of the first component. The request comprises a first destination address within a local memory of the first component and a first size.

The computing system may be an electronic system comprising one or more processing elements, memory elements, and interconnection infrastructure capable of executing instructions and performing computational tasks, as described previously. The computing system may comprise a plurality of interconnected components that communicate via buses, networks, or other communication interfaces. The computing system may be implemented as a system-on-chip (SoC) integrating multiple functional blocks on a single semiconductor die, or may comprise multiple discrete components.

For example, the first component (also referred to as or intellectual property (IP) block) of the computing system may be a functional unit within the computing system that performs a specific set of operations. The first component may comprise dedicated processing circuitry, local memory resources, and interface circuitry for communication with other components including the apparatus 400. The first component may be a power management controller, a graphics controller, a system-level controller, a communications processor, a security processor, an audio processor, a video encoder, a video decoder, an image signal processor, a neural processing unit, a digital signal processor, a memory controller, or any other specialized processing unit. In some examples, the first component may be connected to the apparatus 400 through the interface circuitry 420. The interface circuitry 420 may enable communication between the processing circuitry 430 of the apparatus 400 and the first component through buses, mailbox interfaces, message queues, register-based interfaces, interconnect fabrics, or other inter-component communication mechanisms. The first component may transmit requests to the apparatus 400 through the interface circuitry 420, and the apparatus 400 may transmit acknowledgements and commands through the interface circuitry 420.

In some examples, the first component may be physically integrated within the SoC alongside the apparatus 400, or may be implemented as a discrete processing unit connected to the apparatus 400 through communication interfaces. In some examples, the SoC may consolidate the apparatus 400 and the first component onto a single semiconductor substrate or die. The apparatus 400 and the first component may be fabricated together within the SoC manufacturing process. The apparatus 400 and the first component may communicate through on-chip interconnect fabrics, buses, or network-on-chip architectures rather than through external interfaces. The integration within the SoC may enable faster communication between the apparatus 400 and the first component compared to discrete implementations, may reduce power consumption, and may enable more efficient transfer of configuration data from non-volatile memory to the local memory of the first component.

In some examples, the apparatus 400 may be a boot controller, for example a boot controller of the computing system. For example, the boot controller may refer to a dedicated component comprising hardware and/or software/firmware subsystems responsible for managing initialization, authentication, and configuration distribution to components during system startup and boot processes. The boot controller may be a separate functional unit distinct from components such as power management controllers, graphics controllers, or system-level controllers, and distinct from main processing units such as central processing units. The boot controller may orchestrate the sequence of operations required to bring the computing system from a powered-off or reset state to a fully operational state. The apparatus 400 implementing the boot controller may comprise the interface circuitry 420 for communicating with components and with non-volatile memory, the processing circuitry 430 for executing boot controller firmware and managing the boot process, and the storage circuitry 440 for storing boot controller firmware and temporary data during boot operations. The boot controller may be implemented as a dedicated microcontroller, a security processor, an embedded controller, or an intellectual property block within a system-on-chip with its own processing resources and firmware

For example, the firmware of the first component may refer to executable program code specific to the first component that defines the operational behavior, control logic, and functional routines of the first component. The firmware may be stored in non-volatile memory (for example the non-transitory medium 140 of FIG. 1) and may be loaded into the local memory of the first component when the first component is initialized. The firmware may include boot code, initialization routines, operational control algorithms, communication protocols, and error handling procedures specific to the first component's function within the computing system.

For example, the configuration data corresponding to the firmware of the first component may comprise parameters to control the behavior of the firmware during execution. The configuration data may define operational limits, performance characteristics, timing parameters, voltage and frequency settings, thermal thresholds, feature enablement flags, and other adjustable parameters that affect how the firmware operates. The configuration data may be separate from the firmware itself and may vary between different system configurations, product variants, or operational modes even when the same firmware is used. The configuration data may be stored in non-volatile memory accessible to the apparatus 400 and may need to be transferred to the local memory of the first component before or during execution of the firmware.

For example, the processing circuitry 430 may be configured to receive, from the first component of the computing system (see for example apparatus 100 in FIG. 1), a request to initiate a single-block transfer of full configuration data corresponding to the firmware of the first component. The request may be a message, command, or instruction transmitted from the first component to the apparatus 400 through the interface circuitry 420. The request may be received during a boot sequence or initialization phase when the first component requires its configuration data to become operational. The request may be formatted according to a defined communication protocol between the first component and the apparatus 400.

For example, the request may comprise a first destination address within a local memory of the first component specifying where the configuration data should be loaded. The request may be generated by processing circuitry (for example processing circuitry 130 of FIG. 1) of the first component executing firmware of the first component, and may be transmitted from the first component to the apparatus 400 through communication interfaces connecting the first component to the apparatus 400. The request may be received by the interface circuitry 420 of the apparatus 400 and passed to the processing circuitry 430 for processing. The first destination address may be a physical memory address, a virtual memory address, or an offset within the local memory of the first component. The first destination address may point to a region of static random-access memory (SRAM), dynamic random-access memory (DRAM), or another type of memory local to the first component. The local memory of the first component may be memory physically integrated within the first component, memory located in close proximity to the first component within a system-on-chip, or memory directly accessible to the first component through dedicated memory interfaces. The first component may allocate or reserve a portion of its local memory to receive the configuration data before transmitting the request, and may specify this allocated region through the first destination address included in the request. The first component may determine the appropriate size of the memory region to allocate based on the expected size of the configuration data. The first destination address may enable the apparatus 400 to direct a hardware copy engine to write the configuration data to the correct location within the local memory of the first component, ensuring that the configuration data is placed where the firmware of the first component expects to find it for subsequent parsing and application operations.

For example, the single-block transfer of full configuration data may comprise the entirety of configuration data from non-volatile memory to the local memory of the first component as one contiguous, uninterrupted transfer. The single-block transfer may write the configuration data continuously into a contiguous region of the local memory at the first destination address without subdivision into multiple separate transfer operations. The full configuration data may comprise the complete set of all configuration parameters required by the firmware of the first component, including the configuration setting needed for the firmware to operate the first component according to its intended function. The configuration data may be stored in non-volatile memory in contiguous or non-contiguous locations, and the apparatus 400 may assemble the data into a single contiguous block before or during the transfer. The single-block transfer may be initiated by one transfer command issued by the apparatus 400 to a hardware copy engine, and may be executed as one continuous write operation to the local memory of the first component. The single block may be received by the first component as one contiguous data unit residing in one continuous memory region of the local memory, starting at the first destination address and extending through adjacent memory addresses for the length specified by the first size. The single-block transfer may contrast with multi-chunk transfers where configuration data is divided into multiple small segments, such as 32-bit chunks, that are transferred through multiple separate commands, or with multi-block transfers where data is divided into multiple separate blocks transferred at different times or to non-contiguous memory locations.

In some examples, the non-volatile memory may comprise a Serial Peripheral Interface (SPI) flash memory. For example, an SPI flash memory may refer to a type of non-volatile memory device that uses the Serial Peripheral Interface protocol for communication and data access. The SPI flash memory may store firmware instructions and configuration data persistently, retaining the data even when power is removed from the computing system. The SPI flash memory may be accessed by the processing circuitry 430 through serial communication using clock, data input, data output, and chip select signals according to the SPI protocol. The SPI flash memory may provide relatively fast read access times suitable for boot operations while maintaining non-volatile storage characteristics. In other examples, the non-volatile memory may comprise other types of non-volatile storage such as embedded Multi-Media Card (eMMC) memory, Universal Flash Storage (UFS), NOR flash memory, NAND flash memory, resistive random-access memory (ReRAM), phase-change memory (PCM), magnetoresistive random-access memory (MRAM), or other persistent storage technologies. The non-volatile memory may be integrated within a system-on-chip alongside the apparatus 400 and the components, or may be implemented as a separate memory device connected to the computing system through appropriate interfaces.

The processing circuitry 430 is further configured to authenticate the configuration data from one or more source locations in a non-volatile memory in response to the request. The authentication may be performed after receiving the request from the first component and before initiating the transfer of the configuration data to the local memory of the first component. The processing circuitry 430 may read the configuration data from the one or more source locations in the non-volatile memory where the configuration data is stored. The one or more source locations may be contiguous locations within a single region of the non-volatile memory, or may be non-contiguous locations distributed across multiple regions, sectors, or addresses of the non-volatile memory. The processing circuitry 430 may assemble the configuration data from the multiple source locations into a complete dataset if the configuration data is stored in non-contiguous locations. The authentication may verify that the configuration data is authentic, has not been tampered with or corrupted, and is authorized for loading into the first component. The authentication may use cryptographic techniques to verify the integrity and authenticity of the configuration data before the configuration data is transferred to the first component. The authentication may protect against loading of unauthorized, modified, or corrupted configuration data that could cause the first component to malfunction or create security vulnerabilities

In some examples, to authenticate the configuration data may comprise to assemble the full configuration data from a plurality of data segments stored in non-contiguous locations in the non-volatile memory prior to authentication into a single block of configuration data. The configuration data for the first component may be stored across multiple separate regions, sectors, or address ranges within the non-volatile memory rather than in one continuous storage location. The processing circuitry 430 may read the plurality of data segments from their respective non-contiguous source locations in the non-volatile memory. The processing circuitry 430 may combine or concatenate the data segments to form a complete, assembled block of the full configuration data. The assembly may occur in a temporary buffer or working memory accessible to the processing circuitry 430. After assembling the full configuration data from the non-contiguous segments, the processing circuitry 430 may then perform authentication on the assembled single block of configuration data as a complete unit. The authentication may verify a cryptographic signature, hash value, or checksum calculated over the entire assembled block rather than authenticating individual segments separately. This approach may ensure that the complete configuration dataset is verified for integrity and authenticity as a cohesive whole before transfer to the first component. The assembly prior to authentication may also prepare the configuration data in the contiguous block format required for the single-block transfer to the local memory of the first component

The processing circuitry 430 is further configured to issue a first single load command to a hardware copy engine. The command may comprise the first destination address to cause the hardware copy engine to transfer the authenticated full configuration data as a single block to the first destination address. The first single load command may be one command that initiates the transfer of the full configuration data as a single block. The command may be single in that it is one command rather than multiple sequential commands required to transfer the configuration data. For example, the first single load command may be issued by the processing circuitry 430 writing command parameters to control registers of the hardware copy engine, transmitting a command message to the hardware copy engine through an interface, or asserting control signals that trigger the hardware copy engine to begin a transfer operation. The first single load command may include or specify the first destination address indicating where in the local memory of the first component the configuration data should be written. The first single load command may comprise or specify a source address indicating where the authenticated full configuration data resides, such as an address in a buffer where the processing circuitry 430 has assembled and authenticated the configuration data. The first single load command may comprise or specify the first size indicating the total amount of data to be transferred. The first single load command may be structured as a data structure, register write sequence, or message format comprising parameter fields for the destination address, source address, and size.

For example, the first single load command may comprise a structured set of parameters organized as fields within a command format. The command may comprise a destination address field specifying the first destination address, indicating the starting location in the local memory of the first component where the configuration data should be written. The destination address field may contain a memory address value expressed in hexadecimal, binary, or another addressing format, and may specify a physical address, virtual address, or offset within the local memory address space of the first component. The command may comprise a source address field specifying where the hardware copy engine should read the configuration data. The source address may point to a location in non-volatile memory where the configuration data is stored, may point to a buffer or temporary memory where the processing circuitry 430 has assembled and authenticated the configuration data, or may point to another accessible memory location containing the authenticated full configuration data. The source address field may enable the hardware copy engine to locate and retrieve the data to be transferred. The command may comprise a size field specifying the first size, indicating the total amount of data to be transferred measured in bytes, words, kilobytes, or another data measurement unit. The size field may inform the hardware copy engine of how many bytes or words to read from the source address and write to the destination address, defining the length of the transfer operation.

For example, the first single load command may comprise additional parameter fields beyond the destination address, source address, and size. The command may include a transfer mode field specifying characteristics of the transfer operation, such as whether the transfer should proceed as a burst transfer, a streaming transfer, or with specific timing constraints. The command may include a priority level field indicating the urgency or importance of the transfer relative to other operations, which may affect how the hardware copy engine schedules or executes the transfer if multiple operations are pending. The command may include completion notification parameters specifying how the hardware copy engine should signal completion of the transfer, such as setting a status flag, generating an interrupt, or sending a completion message. The command may include error handling parameters specifying actions to take if errors occur during the transfer. The command may include security parameters such as access permissions or encryption settings if the transfer involves secure data.

For example, the hardware copy engine may be to dedicated hardware circuitry configured to perform data transfer operations from a source location to a destination location without requiring continuous intervention from processing circuitry. The hardware copy engine may execute data movement operations independently after receiving a command specifying transfer parameters. The hardware copy engine may read data from a source address and write data to a destination address automatically, freeing processing circuitry from the burden of managing individual read and write operations for each byte or word of data. The hardware copy engine may be implemented as a hardware finite state machine (FSM) that sequences through states to perform read operations, data buffering, and write operations. The hardware copy engine may be implemented as a direct memory access (DMA) controller or similar specialized transfer logic. The hardware copy engine may operate concurrently with processing circuitry, allowing the processing circuitry to perform other tasks while the hardware copy engine executes the data transfer.

For example, the hardware copy engine (such as an FSM) may be associated or may be physically integrated with the first component. The hardware copy engine associated with the first component may be dedicated to performing transfers to the local memory of the first component. The hardware copy engine may be physically integrated with the first component within a SoC, may be located in proximity to the first component, or may have dedicated access pathways to the local memory of the first component.

In some examples, the single load command may be issued directly to the hardware copy engine associated with the first component to initiate the transfer. For example, each component within the computing system may have its own associated hardware copy engine rather than all components sharing one centralized copy engine. This distributed architecture may enable multiple components to receive configuration data concurrently or in overlapping time periods, as each hardware copy engine can operate independently. The use of component-associated hardware copy engines may avoid creating a bottleneck where all configuration transfers must proceed sequentially through a single shared resource. The processing circuitry 430 of the apparatus 400 may issue commands to different hardware copy engines associated with different components, and each hardware copy engine may execute its transfer independently and potentially simultaneously with other hardware copy engines performing transfers to other component.

In some examples, the single block of full configuration data may comprise at least one of a power limit, a voltage-frequency table, or a thermal threshold. A power limit may specify a maximum power consumption value, a maximum current value, a maximum wattage, or power budget constraints that the first component should observe during operation. The power limit may define how much electrical power the first component is allowed to consume under various operating conditions, and the firmware of the first component may use the power limit to regulate its operations to remain within the specified power budget. A voltage-frequency table may specify relationships between operating voltages and operating frequencies, defining voltage and frequency pairs or operating points that the first component may use for different performance states or power modes. The voltage-frequency table may contain multiple entries each associating a specific voltage level with a corresponding frequency level, enabling the first component to select appropriate voltage and frequency combinations for different workload demands or efficiency targets. A thermal threshold may specify temperature limits, temperature warning levels, or thermal management trigger points that control thermal protection mechanisms or thermal response behaviors of the first component. The thermal threshold may define temperatures at which the first component should reduce performance, activate cooling mechanisms, or initiate protective shutdown procedures to prevent thermal damage.

The configuration data may include these parameters along with other configuration settings such as timing values defining clock periods or delay settings, feature enablement flags indicating which optional features or capabilities should be activated or deactivated, operational mode settings specifying default or preferred operating modes, calibration values for adjusting sensor readings or control outputs, register initialization values for configuring hardware registers, memory allocation parameters defining memory region sizes or addresses, communication parameters specifying protocol settings or interface configurations, or other adjustable settings that customize the operation of the first component according to system requirements, product specifications, or operational policies. For a power management controller, the configuration data may include voltage regulation settings for multiple voltage rails, power state transition parameters, current limits for each power domain, and timeout values for power management events. For a graphics controller, the configuration data may include display timing parameters, memory bandwidth allocations, rendering pipeline configurations, and performance tuning parameters.

The processing circuitry 430 further comprises transmitting a first acknowledgement to the first component upon completion of the transfer. The first acknowledgement may refer to a response message, signal, or notification transmitted from the apparatus 400 to the first component confirming that the requested transfer operation has been completed successfully. The first acknowledgement may inform the first component that the full configuration data has been loaded into the local memory at the first destination address and is now available for the first component to access, parse, and apply. The transmission of the first acknowledgement may occur after the hardware copy engine completes writing all data to the local memory of the first component and reports completion status to the processing circuitry 430. The hardware copy engine may signal completion to the processing circuitry 430 through a status register, completion flag, interrupt, or completion message indicating that the transfer operation has finished. The processing circuitry 430 may verify that the transfer completed without errors by checking completion status information from the hardware copy engine before transmitting the first acknowledgement. The processing circuitry 430 may transmit the first acknowledgement through the interface circuitry 420 to the first component using communication interfaces connecting the apparatus 400 to the first component.

The first acknowledgement may be transmitted upon completion of the transfer to synchronize the operations of the apparatus 400 and the first component, ensuring that the first component does not attempt to access or parse the configuration data before the data has been fully loaded into the local memory. The first component may wait for the first acknowledgement before initiating parsing operations, as accessing the configuration data prematurely while the transfer is still in progress could result in the first component reading incomplete or invalid data. The first acknowledgement serves as a trigger or synchronization signal indicating that it is safe for the first component to proceed with parsing and applying the configuration data. The first acknowledgement may be implemented as a message sent over a communication interface such as a mailbox interface or message queue, as a status bit or flag set in a shared register accessible to the first component, as an interrupt signal asserted to the processing circuitry of the first component, or as a response message corresponding to the original request message sent by the first component. The first acknowledgement may include additional information such as a completion status code indicating successful completion, error flags or error codes if any errors occurred during the transfer, a checksum or hash value of the transferred data enabling the first component to verify data integrity, or a timestamp indicating when the transfer completed. Upon receiving the first acknowledgement, the processing circuitry of the first component may proceed to parse the configuration data residing in the local memory and apply the configuration settings derived from the parsed data

In some examples, transfer as a single block in a single operation as described in this disclosure is performed without an intermediary staging firmware slicing the configuration data into a plurality of chunks for transmission via a plurality of mailbox commands. The intermediary staging firmware may refer to a firmware module that acts as an intermediary between the boot controller and the destination component, receiving configuration data from the boot controller, processing or reformatting the data, and forwarding the data to the destination component. In other architectures, such intermediary staging firmware may receive configuration data, divide or slice the data into smaller chunks such as 32-bit chunks, and transmit each chunk separately to the destination component through individual mailbox commands. Each mailbox command may carry one chunk of data and may require separate processing, acknowledgment, and handling by the destination component. The approach described herein may eliminate the intermediary staging firmware entirely, enabling the configuration data to be transferred directly from the boot controller to the local memory of the first component as a single block through one transfer operation executed by the hardware copy engine. The elimination of the intermediary staging firmware may simplify the firmware architecture, reduce the number of firmware entities involved in configuration distribution, reduce boot time by avoiding the overhead of multiple mailbox transactions, and reduce the complexity of maintaining and coordinating multiple firmware modules during the boot process.

The apparatus 400 may enable improved boot time performance and simplified firmware architecture for configuration data distribution in computing systems. The apparatus 400 may reduce boot latency by enabling single-block transfers of complete configuration datasets rather than requiring multiple separate transfer operations or mailbox commands for individual configuration parameters. The apparatus 400 may authenticate configuration data as complete blocks before transfer, providing enhanced security compared to transmitting configuration parameters piecemeal through multiple observable mailbox transactions. The apparatus 400 may implement a unified transfer mechanism applicable to all components regardless of their specific configuration requirements, improving scalability and reducing maintenance overhead as the apparatus 400 does not need to understand or interpret the specific configuration formats used by different components. The apparatus 400 may enable concurrent or overlapping configuration transfers to multiple components by issuing commands to component-specific hardware copy engines, avoiding bottlenecks that would occur with a single shared transfer mechanism. The apparatus 400 may reduce interrupt handling overhead at destination components because the single-block transfer completes as one operation rather than requiring the component to service multiple high-priority interrupt events for individual data chunks, allowing components to initialize more efficiently and enabling faster boot sequences for the computing system.

In some examples, the first component may be a power management controller acting as a boot orchestrator. The power management controller may be responsible for regulating voltage levels, controlling power states, managing power delivery to various subsystems, and coordinating power-related operations within the computing system. The power management controller may be particularly suited to act as a boot orchestrator because the power management controller may control power delivery to other components and may need to ensure that power rails are stable and properly sequenced before other components can safely initialize. The power management controller acting as boot orchestrator may coordinate the initialization sequence of multiple components within the computing system by determining which components should be initialized, in what order the initialization should occur, and when each component is ready to proceed to the next boot stage. The power management controller may first request and receive its own configuration data from the apparatus 400 as described in the preceding claims, enabling the power management controller to configure itself and become operational. After successfully loading and applying its own configuration settings, the power management controller may then coordinate the initialization of other components by requesting configuration data loads for those components.

The processing circuitry 430 may be further configured to receive, from the boot orchestrator, a second request to initiate a single-block transfer of full second configuration data corresponding to a firmware of a second component. The processing circuitry 430 may be further configured to issue a second single load command to the hardware copy engine to cause the transfer of the second configuration data to the second component. The second request may be similar in structure to the first request, and may comprise a second destination address within a local memory of the second component and a second size indicating the amount of the second configuration data. The second request may be transmitted by the power management controller acting as boot orchestrator after the power management controller determines that the second component should be initialized based on boot sequence logic or system dependencies. The processing circuitry 430 may respond to the second request by authenticating the second configuration data from one or more source locations in the non-volatile memory, assembling the second configuration data if stored in non-contiguous locations, and issuing a second single load command to a hardware copy engine associated with the second component. The second single load command may specify the second destination address and the second size to cause the hardware copy engine to transfer the authenticated full second configuration data as a single block to the local memory of the second component. The apparatus 400 may thus serve multiple components by responding to requests from a boot orchestrator component that coordinates the initialization sequence, enabling centralized boot coordination while maintaining the benefits of single-block configuration transfers for each component.

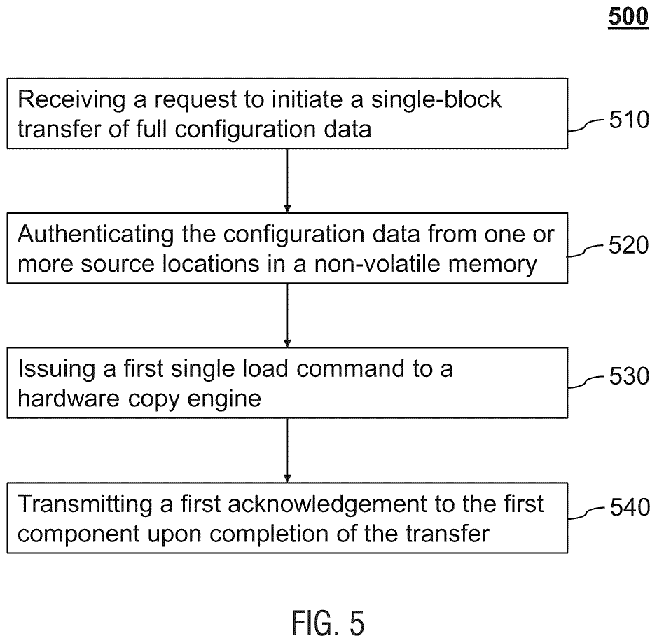

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-8).

FIG. 5 illustrates a flowchart of an example of a method 500. The method 500 may, for instance, be performed by an apparatus as described herein, such as apparatus 400. The method 500 comprises receiving 510, from a first component of a computing system, request to initiate a single-block transfer of full configuration data corresponding to a firmware of the first component. The request comprises a first destination address within a local memory of the first component and a first size. The method 500 comprises further in response to the request, authenticating 520 the configuration data from one or more source locations in a non-volatile memory. The method 500 comprises further issuing 530 a first single load command to a hardware copy engine, the command comprising the first destination address to cause the hardware copy engine to transfer the authenticated full configuration data as a single block to the first destination address. The method 500 comprises further transmitting 540 a first acknowledgement to the first component upon completion of the transfer.

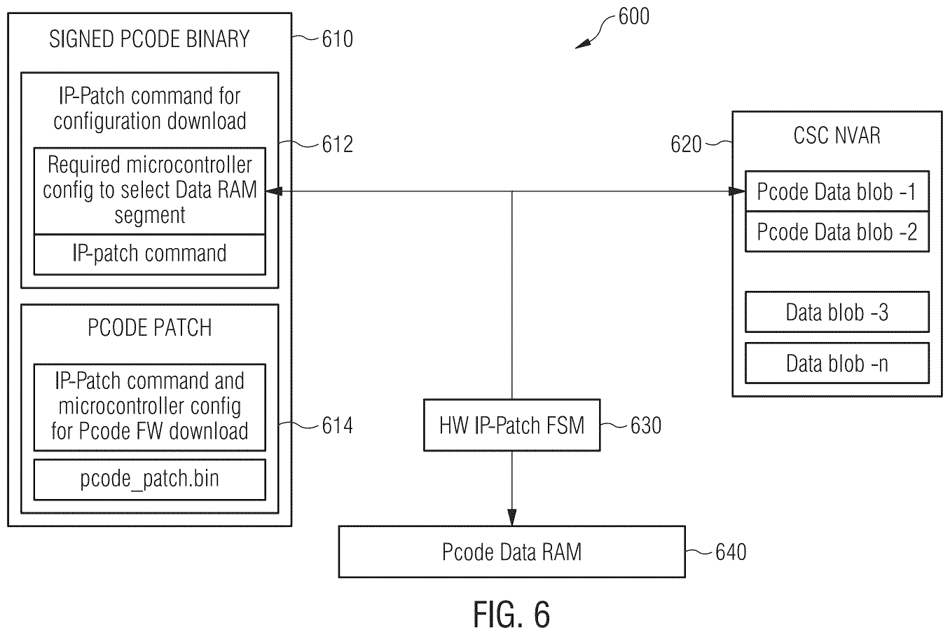

Further details and aspects are mentioned in connection with the examples described above or below. The example shown in FIG. 5 may include one or more optional additional features corresponding to one or more aspects mentioned in connection with the proposed concept or one or more examples described above (e.g., FIGS. 1-4) or below (e.g., FIGS. 6-8).

FIG. 6 illustrates an example of a system 600 for configuration data distribution in a computing system. The system 600 comprises a component 610 (such as the power management firmware signed Pcode binary 610) comprising an IP-Patch command for configuration download and a Pcode patch 614. That is the signed Pcode binary 610 represents firmware instructions of the component (Pcode firmware), which in this example may be a power management controller (Pcode) acting as a boot orchestrator. The signed Pcode binary 610 comprises an IP-Patch command for configuration download 612. The IP-Patch command 612 comprises required microcontroller configuration to select Data RAM segment and the IP-patch command itself (single load command). The IP-Patch command 612 may specify a destination address within the Pcode Data RAM 640 and a size of configuration data to be transferred. The signed Pcode binary 610 may be loaded by the boot controller 620 into the local memory 640 of the component 610 before the component begins executing the firmware instructions.

The Pcode patch 614 represents a data structure or binary file comprising the IP-Patch command and microcontroller configuration for Pcode firmware download. The Pcode patch 614 may include the IP-Patch command (single load command) and microcontroller configuration information that specifies parameters for the configuration download operation (single-block transfer). The Pcode patch 614 may be stored alongside or as part of the signed Pcode binary 610 and may contain pcode_patch. bin file data.

The system 600 further comprises a boot controller (such as the converged security controller Non-Volatile Automatic Registration (CSC NVAR)) 620. The CSC NVAR 620 represents a region of non-volatile memory storing configuration data for the component 610 of the computing system. The CSC NVAR 620 stores multiple configuration data blobs including Pcode DATA blob-1, Pcode DATA blob-2, DATA blob-3, and DATA blob-n. For example, the Pcode DATA blob-1 and the Pcode DATA blob-2 are the configuration data of the Pcode component 610 which are stored and fetch from different locations within the NVM memory, that is configuration data may be stored in non-contiguous locations (one or more source locations) within the CSC NVAR 620, with different blobs representing different segments of configuration data or configuration data for different components. The Pcode DATA blob-1 and the Pcode DATA blob-2 may represent full configuration data for the component 610. The boot controller 620 may read and authenticate the configuration data from Pcode DATA blob-1 and Pcode DATA blob-2 before initiating transfer to the destination component 610.

The system 600 further comprises a hardware IP-Patch FSM 630. The hardware IP-Patch FSM 630 represents a hardware copy engine associated with the first component. The hardware IP-Patch FSM 630 comprises a hardware finite state machine (FSM) configured to perform data transfer operations from source locations to the Pcode Data RAM 640. The hardware IP-Patch FSM 630 may receive a single load command (IP-Patch command) from the boot controller 620 specifying a source address, a destination address, and a size of data to transfer. Upon receiving the command, the hardware IP-Patch FSM 630 may execute the transfer by reading configuration data and writing it continuously to the Pcode Data RAM 640 as a single contiguous block. The hardware IP-Patch FSM 630 may be physically integrated with the first component or may be closely associated with the first component to enable efficient transfer to the component's local memory.

The system 600 further comprises a component local memory (such as the Pcode Data RAM) 640. The Pcode Data RAM 640 represents local memory of the first component where the full configuration data is loaded as a single block. The Pcode Data RAM 640 may comprise static random-access memory (SRAM) or another type of memory local to the component 610 (Pcode, power management controller). The configuration data may be written to the Pcode Data RAM 640 starting at a destination address (first destination address) specified in the IP-Patch command 612 and continuing sequentially for the size specified in the command. After the configuration data is loaded into the Pcode Data RAM 640, the processing circuitry of the first component may parse the configuration data to apply configuration settings.

The component 610 may require its own configuration data to be communicated to it during the boot flow. In some examples, the Pcode firmware component 610 may act as a boot orchestrator sends a request to the boot controller 620 to download Pcode configurations. That is Pcode component 610 may also initiate requests to download System Controller IP configuration (configuration data for a second component), which may include system controller and GFSP configurations or the like. The flow is the same as used for Pcode configurations as described above, where boot controller 620 authenticates and starts download using the same IP-patch command communicated by system controller firmware upfront to load into local system controller SRAM.

This flow can be used for any other firmware component requiring its configurations to be downloaded into local SRAM (local memory). The flow requires each component to allocate sufficient space in its local SRAM (local memory) to store the configuration data at boot time.

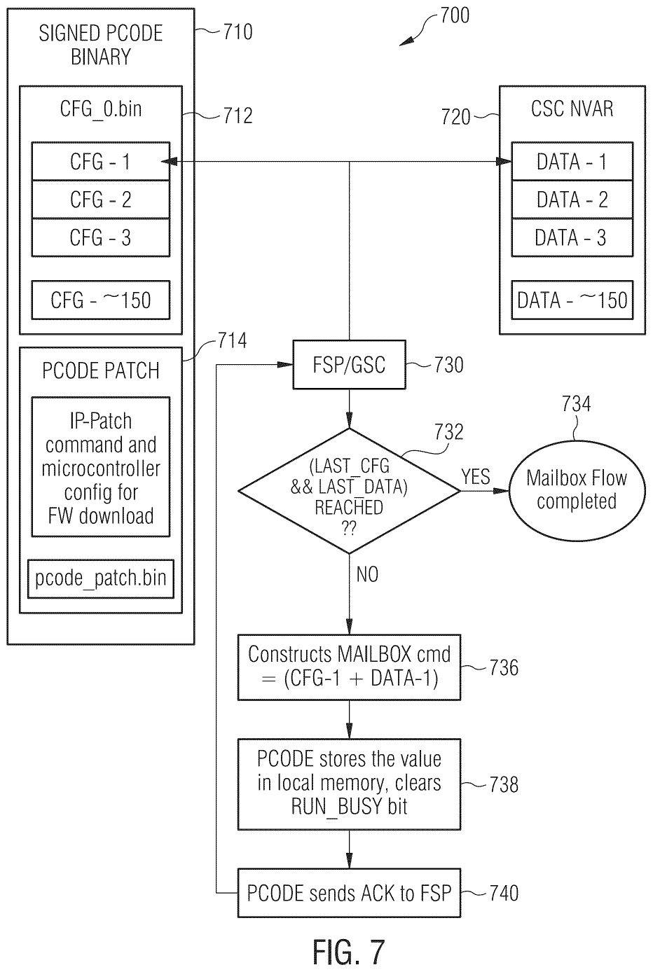

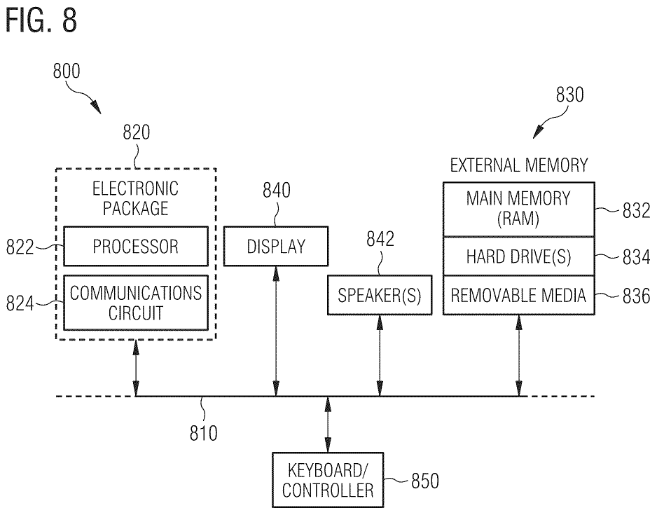

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-8).

For example, with regards to discrete graphics processing units (DGPUs) or the like boot time configurations have been communicated by Converged Security Controller (CSC) firmware authenticating and reading from flash memory. For example, Graphics Firmware Support Package (GFSP) firmware running on the security controller receives the data sent by CSC and has detailed knowledge of the configuration data structure to split the data and parse it using a custom 32-bit chunking method to send data 32 bits at a time to another component, specifically Pcode firmware (power management firmware). An additional complexity in this approach may be that both the firmware on CSC and the firmware on the power unit must be synchronized or “locked” in order to pass and parse the data correctly. This synchronization may create a dependency where any firmware changes that impact the configuration data structure require coordinated updates across multiple firmware modules. This approach may add to the overhead of maintenance and complexity due to the increasing number of configurations required and the frequency of late changes to configuration requirements. All early binding and late binding configurations may be communicated in this approach through messaging protocols such as mailbox communication or through downloads of chunks of data to shared memory. This approach may require higher maintenance by several components including the security boot agent (CSC firmware), GFSP staging firmware, Pcode firmware, and other components requiring configurations, due to the varying requirements by different firmware components. The approach may create overhead due to the need for GFSP to service as a staging agent, parsing all boot time configurations without having detailed knowledge about the configurations themselves, to send to destination components via mailbox messages, with each destination component requiring dedicated application programming interfaces (APIs) or handlers for each configuration parameter. For shared code bases, separate or duplicate APIs are required to maintain small flow changes across different product generations, creating backward compatibility overhead. With the increasing number of firmware components and the increasing number of system configurations or stock keeping units (SKUs), maintaining each component's individual requirements becomes difficult and not scalable. This approach may also negatively impact boot time performance in the case of Pcode firmware due to the need to add interrupt handlers for each mailbox command sent by GFSP and serve them as high priority events during the early boot sequence, with each interrupt introducing latency and overhead.

In some examples, methods involved Pcode firmware requesting CSC firmware to download all configurations related to system-on-chip boot, power management, and thermal management. Upon receiving the request, CSC firmware would authenticate and load the configuration data from flash memory and pass the data to GFSP staging firmware, which then parsed the data and sent all configurations as 32-bit chunks one at a time to Pcode over mailbox messages. The flow communicated configuration data on the fly at boot time, with the data being saved in Pcode data RAM as variables or data structures as each mailbox message was received and processed. This approach did not require separate memory allocation in Pcode SRAM to receive the complete configuration dataset upfront, as the data was processed incrementally through the mailbox message stream. The firmware architecture team attempted to mitigate the messaging overhead by carefully defining mailbox messages to pack as many configurations as possible into single commands to avoid excessive numbers of messages during boot time. However, this approach still required maintaining separate commands for backward compatibility, with some commands potentially becoming obsolete in newer product generations but still needing to be supported in shared firmware code bases.

FIG. 7 illustrates an example of a system 700 for configuration data download in a computing system using a multi-chunk mailbox-based approach. In some examples, the system 700 demonstrates a configuration data transfer architecture that may differ from the single-block transfer approach as disclosed herein, where configuration data is transferred through intermediary staging firmware using multiple separate mailbox commands.

The system 700 comprises a signed Pcode binary component 710 comprising configuration binary (CFG_0.bin) and a Pcode patch 714, a boot controller (CSC NVAR) 720, an FSP/GSC staging firmware 730 carrying out the process steps 732, 734, 736, 738, and/or 740. The signed Pcode binary 710 represents firmware instructions of a component, which in this example may be a power management controller (Pcode). The signed Pcode binary 710 comprises a CFG_0.bin file 712 containing multiple configuration entries CFG-1, CFG-2, CFG-3, through CFG-˜150. These configuration entries may represent individual configuration parameters or small groups of parameters that are to be communicated to the Pcode component. For example, unlike in a single-block transfer approach, system 700 may require the configuration data to be organized as individual configuration entries that will be transmitted separately. The Pcode patch 714 represents a data structure or binary file comprising IP-Patch command and microcontroller configuration for firmware download. The Pcode patch 714 may include command information and may contain pcode_patch. bin file data. The Pcode patch 714 may specify parameters for the configuration download operation in the multi-chunk approach.

The CSC NVAR 720 comprises a region of non-volatile memory storing configuration data for components of the computing system. The CSC NVAR 720 stores multiple configuration data entries including DATA-1, DATA-2, DATA-3, through DATA-˜150. These data entries represent configuration data stored in the non-volatile memory that correspond to the configuration entries in the signed Pcode binary 710. The boot controller 720 may read the configuration data from the CSC NVAR during the configuration distribution process.

The FSP/GSC 730 represents intermediary staging firmware that acts as an intermediary between the boot controller and the destination component. The FSP/GSC staging firmware 730 receives configuration data from the boot controller, processes and reformats the data, and forwards the data to the destination component. The FSP/GSC staging firmware 730 maps individual 32-bit chunks of data to commands and sends one command-data chunk pair at a time to Pcode as mailbox commands. The FSP/GSC staging firmware 730 may be used system 700 but may not be used in the single-block transfer approach described above.

The system 700 may proceed as follows: The Pcode component 710 sends a request to boot controller 720 to initiate configuration download. The boot controller 720 locates the configuration data from the NVAR region (CSC NVAR 720) of flash memory and sends the data to GFSP (FSP/GSC 730). The boor controller 720 finds a list of commands sent by Pcode along with the Pcode firmware binary. The GFSP firmware 730 maps individual 32-bit chunks of data to commands. At decision point 732, the FSP/GSC 730 checks whether the last configuration entry and last data have been reached. If yes (as indicated by path 734), the mailbox flow is completed and the process ends. If no, the process continues to step 736.

At step 736, the FSP/GSC 730 constructs a mailbox command comprising one configuration entry and corresponding data, such as (CFG-1+DATA-1). This represents one command-data chunk pair. The GFSP sends this mailbox command to Pcode. At step 738, Pcode 710 receives the mailbox command and stores the value in local memory. The Pcode component 710 serves each mailbox command as a high priority event, which triggers relevant application programming interfaces (APIs) to validate and save the configuration data in internal data structures. The Pcode clears a RUN_BUSY bit or similar status indicator.

At step 740, Pcode 710 sends an acknowledgement (ACK) to FSP, confirming receipt and processing of the mailbox command. The process then returns to decision point 732 to check if more configuration entries and data remain to be transmitted. This loop continues until all configuration entries (CFG-1 through CFG-˜150) and corresponding data (DATA-1 through DATA-˜150) have been transmitted via individual mailbox commands.

This described flow requires numerous separate mailbox transactions, with each transaction triggering a high-priority interrupt event at the destination component. This approach adds latency due to interrupt handling overhead for each chunk, requires coordination between multiple firmware entities (CSC, FSP/GSC, and Pcode), and necessitates the intermediary staging firmware (FSP/GSC 730) to parse and forward configuration data. This approach may contrast with the single-block transfer method described above, where configuration data is transferred directly to the component's local memory as one contiguous block without intermediary staging firmware and without requiring multiple interrupt-driven mailbox transactions.

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIG. 8).

FIG. 8 illustrates an example of a block diagram of an electronic apparatus 800 incorporating at least one electronic assembly 100, 200, 400 and/or their components and/or methods 300 and/or 500 described herein. Electronic apparatus 800 is merely one example of an electronic apparatus in which forms of the electronic assemblies 100, 200, 400 and/or methods 300/500 described herein may be used. Examples of an electronic apparatus 800 include, but are not limited to, personal computers, tablet computers, mobile telephones, game devices, MP3 or other digital music players, etc. In this example, electronic apparatus 800 comprises a data processing system that includes a system bus 810 to couple the various components of the electronic apparatus 800. System bus 810 provides communications links among the various components of the electronic apparatus 800 and may be implemented as a single bus, as a combination of busses, or in any other suitable manner.

An electronic assembly 820 as describe herein may be coupled to system bus 810. The electronic assembly 820 may include any circuit or combination of circuits. In one embodiment, the electronic assembly 820 includes a processor 822 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 820 are a custom circuit, an application-specific integrated circuit (ASIC), or the like, such as, for example, one or more circuits (such as a communications circuit 824) for use in wireless devices like mobile telephones, tablet computers, laptop computers, two-way radios, and similar electronic systems. The IC can perform any other type of function.

The electronic apparatus 800 may also include an external memory 830, which in turn may include one or more memory elements suitable to the particular application, such as a main memory 832 in the form of random access memory (RAM), one or more hard drives 834, and/or one or more drives that handle removable media 836 such as compact disks (CD), ﬂash memory cards, digital video disk (DVD), and the like.

The electronic apparatus 800 may also include a display device 840, one or more speakers 842, and a keyboard and/or controller 850, which can include a mouse, trackball, touch screen, voice—recognition device, or any other device that permits a system user to input information into and receive information from the electronic apparatus 800.

Further details and aspects are mentioned in connection with the examples described below. The example shown in FIG. 8 may include one or more optional additional features corresponding to one or more aspects mentioned in connection with the proposed concept or one or more examples described above (e.g., FIGS. 1-7).

In the following, some examples of the proposed technique are presented:

An example (e.g., example 1) relates to a non-transitory computer-readable medium storing firmware instructions of a component of a computing system that, when executed by a processing circuitry cause the processing circuitry to perform a method comprising transmitting, to a boot controller of the computing system, a request to initiate a single-block transfer of full configuration data corresponding to the firmware of the component, the request comprising a destination address within a local memory of the component and a size of the configuration data, receiving, from the boot controller, an acknowledgement indicating that the full configuration data has been loaded as a single block into the local memory at the destination address, and in response to the acknowledgement, parsing the single block of the full configuration data residing in the local memory to apply one or more configuration settings for the component.

Another example (e.g., example 2) relates to a previous example (e.g., example 1) or to any other example, further comprising that the method further comprises acting as a boot orchestrator by transmitting a second request to the boot controller to initiate a configuration load for a second component of the computing system.

Another example (e.g., example 3) relates to a previous example (e.g., example 2) or to any other example, further comprising that the second component comprises one of a system-level controller or a graphics controller.

Another example (e.g., example 4) relates to a previous example (e.g., one of the examples 1 to 3) or to any other example, further comprising that the component is a power management controller acting as a boot orchestrator.

Another example (e.g., example 5) relates to a previous example (e.g., one of the examples 1 to 4) or to any other example, further comprising that the method further comprises, prior to transmitting the request, receiving the firmware instructions of the component loaded by the boot controller into the local memory of the component.

Another example (e.g., example 6) relates to a previous example (e.g., one of the examples 1 to 5) or to any other example, further comprising that the component is integrated within a system-on-chip, SoC.

An example (e.g., example 7) relates to an apparatus comprising interface circuitry, machine-readable instructions and processing circuitry to execute the machine-readable instructions to receive, from a first component of a computing system, request to initiate a single-block transfer of full configuration data corresponding to a firmware of the first component, the request comprising a first destination address within a local memory of the first component and a first size, in response to the request, authenticate the configuration data from one or more source locations in a non-volatile memory, issue a first single load command to a hardware copy engine, the command comprising the first destination address to cause the hardware copy engine to transfer the authenticated full configuration data as a single block to the first destination address, and transmit a first acknowledgement to the first component upon completion of the transfer.

Another example (e.g., example 8) relates to a previous example (e.g., example 7) or to any other example, further comprising that to authenticate the configuration data comprises to assemble the full configuration data from a plurality of data segments stored in non-volatile memory prior to authentication into a single block of configuration data.

Another example (e.g., example 9) relates to a previous example (e.g., one of the examples 7 to 8) or to any other example, further comprising that the hardware copy engine comprises a hardware finite state machine, FSM.

Another example (e.g., example 10) relates to a previous example (e.g., example 9) or to any other example, further comprising that the FSM is physically integrated with the first component.

Another example (e.g., example 11) relates to a previous example (e.g., one of the examples 7 to 10) or to any other example, further comprising that the single load command is issued directly to the hardware copy engine associated with the first component to initiate the transfer.

Another example (e.g., example 12) relates to a previous example (e.g., one of the examples 7 to 10) or to any other example, further comprising that the transfer as a single block in a single operation is performed without an intermediary staging firmware slicing the configuration data into a plurality of chunks for transmission via a plurality of mailbox commands.

Another example (e.g., example 13) relates to a previous example (e.g., one of the examples 7 to 12) or to any other example, further comprising that the single load command comprises a parameter field specifying the first destination address and a parameter field specifying the first size.

Another example (e.g., example 14) relates to a previous example (e.g., one of the examples 7 to 13) or to any other example, further comprising that the first component is a power management controller acting as a boot orchestrator, and the processing circuitry is further to execute the machine-readable instructions to receive, from the boot orchestrator, a second request to initiate a single-block transfer of full second configuration data corresponding to a firmware of a second component, and issue a second single load command to the hardware copy engine to cause the transfer of the second configuration data to the second component.

Another example (e.g., example 15) relates to a previous example (e.g., one of the examples 7 to 14) or to any other example, further comprising that the non-volatile memory comprises a Serial Peripheral Interface, SPI, flash memory.

Another example (e.g., example 16) relates to a previous example (e.g., one of the examples 7 to 15) or to any other example, further comprising that the first component comprises at least one of a power management controller, a system-level controller, or a graphics controller.

Another example (e.g., example 17) relates to a previous example (e.g., one of the examples 7 to 16) or to any other example, further comprising that the single block of full configuration data comprises at least one of a power limit, a voltage-frequency table, or a thermal threshold.

Another example (e.g., example 18) relates to a previous example (e.g., one of the examples 7 to 17) or to any other example, further comprising that the apparatus is a boot controller.

Another example (e.g., example 19) relates to a previous example (e.g., one of the examples 7 to 18) or to any other example, further comprising that the apparatus and the first component are integrated within a system-on-chip, SoC.

An example (e.g., example 20) relates to an apparatus comprising interface circuitry, machine-readable instructions and processing circuitry to execute the machine-readable instructions to transmit, to a boot controller of the computing system, a request to initiate a single-block transfer of full configuration data corresponding to the firmware of the component, the request comprising a destination address within a local memory of the component and a size of the configuration data, receive, from the boot controller, an acknowledgement indicating that the full configuration data has been loaded as a single block into the local memory at the destination address, and in response to the acknowledgement, parse the single block of the full configuration data residing in the local memory to apply one or more configuration settings for the component.

Another example (e.g., example 21) relates to a previous example (e.g., example 20) or to any other example, further comprising that the processing circuitry is further to execute the machine-readable instructions to act as a boot orchestrator by transmitting a second request to the boot controller to initiate a configuration load for a second component of the computing system.

Another example (e.g., example 22) relates to a previous example (e.g., example 21) or to any other example, further comprising that the second component comprises one of a system-level controller or a graphics controller.

Another example (e.g., example 23) relates to a previous example (e.g., one of the examples 20 to 22) or to any other example, further comprising that the component is a power management controller acting as a boot orchestrator.

Another example (e.g., example 24) relates to a previous example (e.g., one of the examples 20 to 23) or to any other example, further comprising that the processing circuitry is further to execute the machine-readable instructions to, prior to transmitting the request, receive the firmware instructions of the component loaded by the boot controller into the local memory of the component.

Another example (e.g., example 25) relates to a previous example (e.g., one of the examples 20 to 24) or to any other example, further comprising that the component is integrated within a system-on-chip, SoC.

An example (e.g., example 26) relates to a method comprising transmitting, to a boot controller of the computing system, a request to initiate a single-block transfer of full configuration data corresponding to the firmware of the component, the request comprising a destination address within a local memory of the component and a size of the configuration data, receiving, from the boot controller, an acknowledgement indicating that the full configuration data has been loaded as a single block into the local memory at the destination address, and in response to the acknowledgement, parsing the single block of the full configuration data residing in the local memory to apply one or more configuration settings for the component.

Another example (e.g., example 27) relates to a previous example (e.g., example 26) or to any other example, further comprising acting as a boot orchestrator by transmitting a second request to the boot controller to initiate a configuration load for a second component of the computing system.

Another example (e.g., example 28) relates to a previous example (e.g., example 27) or to any other example, further comprising that the second component comprises one of a system-level controller or a graphics controller.

Another example (e.g., example 29) relates to a previous example (e.g., one of the examples 26 to 28) or to any other example, further comprising that the component is a power management controller acting as a boot orchestrator.

Another example (e.g., example 30) relates to prior to transmitting the request, receiving the firmware instructions of the component loaded by the boot controller into the local memory of the component.

Another example (e.g., example 31) relates to a previous example (e.g., one of the examples 26 to 30) or to any other example, further comprising that the component is integrated within a system-on-chip, SoC.

An example (e.g., example 32) relates to an apparatus comprising a processor circuitry configured to transmit, to a boot controller of the computing system, a request to initiate a single-block transfer of full configuration data corresponding to the firmware of the component, the request comprising a destination address within a local memory of the component and a size of the configuration data, receive, from the boot controller, an acknowledgement indicating that the full configuration data has been loaded as a single block into the local memory at the destination address, and in response to the acknowledgement, parse the single block of the full configuration data residing in the local memory to apply one or more configuration settings for the component.

An example (e.g., example 33) relates to a device comprising means for processing for transmitting, to a boot controller of the computing system, a request to initiate a single-block transfer of full configuration data corresponding to the firmware of the component, the request comprising a destination address within a local memory of the component and a size of the configuration data, receiving, from the boot controller, an acknowledgement indicating that the full configuration data has been loaded as a single block into the local memory at the destination address, and in response to the acknowledgement, parsing the single block of the full configuration data residing in the local memory to apply one or more configuration settings for the component.

Another example (e.g., example 34) relates to a computer program having a program code for performing the method of any one of examples 26 to 31 when the computer program is executed on a computer, a processor, or a programmable hardware component.

An example (e.g., example 35) relates to a non-transitory computer-readable medium storing instructions that, when executed by a processing circuitry cause the processing circuitry to perform a method comprising receiving, from a first component of a computing system, request to initiate a single-block transfer of full configuration data corresponding to a firmware of the first component, the request comprising a first destination address within a local memory of the first component and a first size, in response to the request, authenticating the configuration data from one or more source locations in a non-volatile memory, issuing a first single load command to a hardware copy engine, the command including the first destination address to cause the hardware copy engine to transfer the authenticated full configuration data as a single block to the first destination address, and transmitting a first acknowledgement to the first component upon completion of the transfer.

An example (e.g., example 36) relates to a method comprising receiving, from a first component of a computing system, a request to initiate a single-block transfer of full configuration data corresponding to a firmware of the first component, the request comprising a first destination address within a local memory of the first component and a first size, in response to the request, authenticating the configuration data from one or more source locations in a non-volatile memory, issuing a first single load command to a hardware copy engine, the command comprising the first destination address to cause the hardware copy engine to transfer the authenticated full configuration data as a single block to the first destination address, and transmitting a first acknowledgement to the first component upon completion of the transfer.

Another example (e.g., example 37) relates to a previous example (e.g., example 36) or to any other example, further comprising that to authenticate the configuration data comprises to assemble the full configuration data from a plurality of data segments stored in non-volatile memory prior to authentication into a single block of configuration data.

Another example (e.g., example 38) relates to a previous example (e.g., one of the examples 36 to 37) or to any other example, further comprising that the hardware copy engine comprises a hardware finite state machine, FSM.

Another example (e.g., example 39) relates to a previous example (e.g., example 38) or to any other example, further comprising that the FSM is physically integrated with the first component.

Another example (e.g., example 40) relates to a previous example (e.g., one of the examples 36 to 39) or to any other example, further comprising that the single load command is issued directly to the hardware copy engine associated with the first component to initiate the transfer.

Another example (e.g., example 41) relates to a previous example (e.g., one of the examples 36 to 40) or to any other example, further comprising that the transfer as a single block in a single operation is performed without an intermediary staging firmware slicing the configuration data into a plurality of chunks for transmission via a plurality of mailbox commands.

Another example (e.g., example 42) relates to a previous example (e.g., one of the examples 36 to 41) or to any other example, further comprising that the single load command comprises a parameter field specifying the first destination address and a parameter field specifying the first size.

Another example (e.g., example 43) relates to a previous example (e.g., one of the examples 36 to 42) or to any other example, further comprising that the first component is a power management controller acting as a boot orchestrator, and the method further comprises receiving, from the boot orchestrator, a second request to initiate a single-block transfer of full second configuration data corresponding to a firmware of a second component, and issuing a second single load command to the hardware copy engine to cause the transfer of the second configuration data to the second component.

Another example (e.g., example 44) relates to a previous example (e.g., one of the examples 36 to 43) or to any other example, further comprising that the non-volatile memory comprises a Serial Peripheral Interface, SPI, flash memory.

Another example (e.g., example 45) relates to a previous example (e.g., one of the examples 36 to 44) or to any other example, further comprising that the first component comprises at least one of a power management controller, a system-level controller, or a graphics controller.

Another example (e.g., example 46) relates to a previous example (e.g., one of the examples 36 to 45) or to any other example, further comprising that the single block of full configuration data comprises at least one of a power limit, a voltage-frequency table, or a thermal threshold.

An example (e.g., example 47) relates to an apparatus comprising a processor circuitry configured to receive, from a first component of a computing system, request to initiate a single-block transfer of full configuration data corresponding to a firmware of the first component, the request comprising a first destination address within a local memory of the first component and a first size, in response to the request, authenticate the configuration data from one or more source locations in a non-volatile memory, issue a first single load command to a hardware copy engine, the command comprising the first destination address to cause the hardware copy engine to transfer the authenticated full configuration data as a single block to the first destination address, and transmit a first acknowledgement to the first component upon completion of the transfer.

An example (e.g., example 48) relates to a device comprising means for processing for receiving, from a first component of a computing system, request to initiate a single-block transfer of full configuration data corresponding to a firmware of the first component, the request comprising a first destination address within a local memory of the first component and a first size, in response to the request, authenticating the configuration data from one or more source locations in a non-volatile memory, issuing a first single load command to a hardware copy engine, the command comprising the first destination address to cause the hardware copy engine to transfer the authenticated full configuration data as a single block to the first destination address, and transmitting a first acknowledgement to the first component upon completion of the transfer.

Another example (e.g., example 49) relates to a computer program having a program code for performing the method of example of any one of examples 36 to 46 when the computer program is executed on a computer, a processor, or a programmable hardware component.

Another example (e.g., example 50) relates to a computer-readable medium including program code, when executed, to cause a machine to perform the method of any one of examples 36 to 46

Another example (e.g., example 51) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing firmware instructions of a component of a computing system that, when executed by a processing circuitry cause the processing circuitry to perform a method comprising:
transmitting, to a boot controller of the computing system, a request to initiate a single-block transfer of full configuration data corresponding to the firmware of the component, the request comprising a destination address within a local memory of the component and a size of the configuration data;
receiving, from the boot controller, an acknowledgement indicating that the full configuration data has been loaded as a single block into the local memory at the destination address; and
in response to the acknowledgement, parsing the single block of the full configuration data residing in the local memory to apply one or more configuration settings for the component.

2. The non-transitory computer-readable medium of claim 1, wherein the method further comprises acting as a boot orchestrator by transmitting a second request to the boot controller to initiate a configuration load for a second component of the computing system.

3. The non-transitory computer-readable medium of claim 2, wherein the second component comprises one of a system-level controller or a graphics controller.

4. The non-transitory computer-readable medium of claim 1, wherein the component is a power management controller acting as a boot orchestrator.

5. The non-transitory computer-readable medium of claim 1, wherein the method further comprises, prior to transmitting the request, receiving the firmware instructions of the component loaded by the boot controller into the local memory of the component.

6. The non-transitory computer-readable medium of claim 1, wherein the component is integrated within a system-on-chip, SoC.

7. An apparatus comprising interface circuitry, machine-readable instructions and processing circuitry to execute the machine-readable instructions to:
receive, from a first component of a computing system, request to initiate a single-block transfer of full configuration data corresponding to a firmware of the first component, the request comprising a first destination address within a local memory of the first component and a first size;
in response to the request, authenticate the configuration data from one or more source locations in a non-volatile memory;
issue a first single load command to a hardware copy engine, the command comprising the first destination address to cause the hardware copy engine to transfer the authenticated full configuration data as a single block to the first destination address; and
transmit a first acknowledgement to the first component upon completion of the transfer.

8. The apparatus of claim 7, wherein to authenticate the configuration data comprises to assemble the full configuration data from a plurality of data segments stored in non-volatile memory prior to authentication into a single block of configuration data.

9. The apparatus of claim 7, wherein the hardware copy engine comprises a hardware finite state machine, FSM.

10. The apparatus of claim 9, wherein the FSM is physically integrated with the first component.

11. The apparatus of claim 7, wherein the single load command is issued directly to the hardware copy engine associated with the first component to initiate the transfer.

12. The apparatus of claim 7, wherein the transfer as a single block in a single operation is performed without an intermediary staging firmware slicing the configuration data into a plurality of chunks for transmission via a plurality of mailbox commands.

13. The apparatus of claim 7, wherein the single load command comprises a parameter field specifying the first destination address and a parameter field specifying the first size.

14. The apparatus of claim 7, wherein the first component is a power management controller acting as a boot orchestrator, and the processing circuitry is further to execute the machine-readable instructions to:
receive, from the boot orchestrator, a second request to initiate a single-block transfer of full second configuration data corresponding to a firmware of a second component; and
issue a second single load command to the hardware copy engine to cause the transfer of the second configuration data to the second component.

15. The apparatus of claim 7, wherein the non-volatile memory comprises a Serial Peripheral Interface, SPI, flash memory.

16. The apparatus of claim 7, wherein the first component comprises at least one of a power management controller, a system-level controller, or a graphics controller.

17. The apparatus of claim 7, wherein the single block of full configuration data comprises at least one of a power limit, a voltage-frequency table, or a thermal threshold.

18. The apparatus of claim 7, wherein the apparatus is a boot controller.

19. The apparatus of claim 7, wherein the apparatus and the first component are integrated within a system-on-chip, SoC.

20. An apparatus comprising interface circuitry, machine-readable instructions and processing circuitry to execute the machine-readable instructions to:
transmit, to a boot controller of the computing system, a request to initiate a single-block transfer of full configuration data corresponding to the firmware of the component, the request comprising a destination address within a local memory of the component and a size of the configuration data;
receive, from the boot controller, an acknowledgement indicating that the full configuration data has been loaded as a single block into the local memory at the destination address; and
in response to the acknowledgement, parse the single block of the full configuration data residing in the local memory to apply one or more configuration settings for the component.
